(19) United States
(12) Patent Application Publication
(10) Pub. No.: US 2008/0263184 A1
(43) Pub. Date: Oct. 23, 2008

(54) Tv-Pc Architecture

(75) Inventors: Gerard De Haan, Eindhoven (NL); Cornelis Hermanus Van Berkel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,009

(22) PCT Filed: Nov. 21, 2006
(86) PCT No.: PCT/IB06/54361

§ 371 Date: May 27, 2008

(30) Foreign Application Priority Data
Nov. 30, 2005 (EP) 05111492.4

(51) Int. Cl. G06F 15/177; G06F 9/445

(52) U.S. Cl. 709/220

(57) ABSTRACT

An apparatus includes at least a first hardware part (AP1) and a second hardware part (AP2). Each of the first and second part include a respective processing element (CPU-1, CPU-2) and a respective signal connection to a respective memory element (MEM-1, MEM-2) for providing program code to the processing element of the respective part. The apparatus further includes a third hardware part (AP3) including at least one peripheral element acting as a source and/or destination of data. A fourth hardware part of the apparatus includes an I/O network (AP-4) for enabling communication between elements of the first and third part under control of first configuration data and for enabling communication between elements of the second and third part under control of distinct second configuration data.

### FIELD OF THE INVENTION

The invention relates to an apparatus with two processing parts. The invention further relates to a processing assembly with a processing part and a connection to a further processing part.

### BACKGROUND OF THE INVENTION

The last decade the increased power of personal computers (PCs) and the increased availability of digital content, such as audio and video, has led to a convergence between PCs and the traditional Consumer Electronics (CE) devices, such as rendering devices, like a television or surround amplifier, and storage devices, such as a VCR, rewritable optical storage device, or dedicated hard-disk recorders. An example of a software architecture running on a PC is Microsoft's Multi-Media Centre based on a specialized version of Windows XP. The PC is based on the conventional PC architecture, which in modern PCs uses PCI-express as the main input/output (I/O) architecture (interconnect) between end points. An end point may simply be a circuit, such as a graphics IC, Gigabit Ethernet controller, memory ICs, etc., but may also be a bridge to other sub-networks, like USB, the conventional PCI-bus, SATA, etc. Typically, in a multi-media PC devices (hardware units) that can be accessed directly or indirectly via PCI-express include at least a TV tuner, audio tuner, optical storage device, and hard-disk (e.g. via SATA).

FIG. 1 shows a typical PCI Express-based PC architecture. PCI Express uses point-to-point connections between elements (also sometimes referred to as devices). Shown are elements PE1 to PE6. Each connection includes 2ⁿ (n>=0) dual uni-directional paths. A connection with a single uni-directional path is referred to as x1, a connection with two uni-directional paths x2, with four uni-directional path x4, etc. Switches, such as S₀ and S₁, are used to a hierarchical network. A special form of a switch is the so-called root complex RC, which is the head or root of the system. The root complex supports at least one connection to another device, but typically it supports a few. Each of those connections form a separate hierarchy domain. It is up to the specific implementation of the root complex whether or not communication (and to which extent) is possible between the domains. One of the PCI Express connections of the root complex is to the main switch S₀ in the system. From the switch S0, the root complex is upstream. The switch S₀ typically supports several downstream PCI express connections, some of which may be connected to a further switch, such as S₁. A switch (other than the root complex) is mostly involved in supporting streams between the root complex and one of the downstream peripherals (downstream is away from the root complex). Peer-to-peer communication between two peripherals downstream of the switch is the exception. In that case it is managed by the switch. Certain devices connected to a bridge or the root complex may actually be bridges, shown as BR, e.g. to PCI or USB. In each PCI express system there is only one root complex RC, that is also responsible for configuration of the system, including the switches. The configuration covers many aspects, such as enumeration of the elements present in the PCI express network (determining the elements present and their functions), supporting hot plugging of elements, configuring virtual channels, port arbitration tables, power management, error reporting, etc. Most PC desktops use for the I/O (Input/Output) two main ICs, a GMCH (Graphics and Memory Controller Hub) and a ICH (I/O Controller Hub). A common mapping of these ICs on the PCI Express architecture is to integrate the root complex into the GMCH and directly connecting the memory MEM and the graphics subsystem GRAPH to the GMCH (=root complex) as is shown in FIG. 1. The processor CPU is also connected directly to the root complex. The ICH then integrates the main switch S₀.

Using a multi-media PC based on PCI express in general gives enough bandwidth and functionality (e.g. support of isochronous streams) to effectively support multi-media applications commonly present in PCs (e.g. games) as well as CE applications like viewing HD TV with surround sound. In practice, however, PCs and CE devices (in particular TVs) have a different origin, which is still reflected in current devices. For example, graphics processing is of a different nature. In a PC traditionally it was an application program that provided pixel input for a window whenever there was change. The graphics systems determined for each screen pixel from which window it originated and what its value should be (inverse mapping). In TVs traditionally an entire image changes at fixed rates (e.g. 25 frames per second). The graphics system is designed for this and continuously maps input pixels on to screen pixels, in the mean time performing all sorts of video processing such as scaling. Both types of graphics processing have achieved a high level of sophistication, where traditional PC graphics is superior in dealing with 3D games and high-end TV graphics is superior in dealing with HD Television signals and real-time video conversion/scaling. Many more differences exist between TVs and PCs, for example a PC has always been open and incorporated many applications. This has resulted in relatively heavy-weight operating systems which are inherently slow in booting. The openness and many applications with unpredictable interaction make a PC more prone to crashing. TVs have traditionally been closed, have considerable fewer applications and consequently have a shorter boot time, are more responsive to user input and less prone to crashing.

Some attempts have been made on letting a multi-media PC perform more like a CE device in responsiveness and reliability. For example, multi-media PCs are known that that support a dual-mode boot. In a first mode, very limited functionality is available, typically the device only performs audio functions. The windows operating system is not booted, instead a simple operating system is booted from ROM. This reduces the boot-up time, the responsiveness to user input and the reliability. If the user wants more advanced functions (typically an image is required), the full PC is booted in the second mode. The first mode uses thus a subset of the second mode. The system has one processor that depending on the mode is loaded with software. The modes are mutually exclusive.

### SUMMARY OF THE INVENTION

It is an object of the invention to provide an improved architecture for supporting two sets of processing requirements.

To meet an object of the invention, an apparatus includes at least a first hardware part and a second hardware part, where each of the first and second part include a respective processing element and a respective signal connection to a respective memory element for providing program code to the processing element of the respective part;

the apparatus further includes a third hardware part including at least one peripheral element acting as a source and/or destination of data; and a fourth hardware part including an I/O network for enabling communication between elements of the first and third part under control of first configuration data and for enabling communication between elements of the second and third part under control of distinct second configuration data. In this way an architecture is made with two processing parts, that may each be targeted at specific functionality, where peripherals can easily be shared. Access to the peripherals by each of the processing part is under control of respective configuration data. It is not required that each part has its own peripherals. For the invention it is irrelevant whether the first or second part include a single processing core, a single processor with multiple cores, or a multi-processor (possibly each with multiple cores). A part is defined by the processing elements and associated program.

This architecture enables, as described in claim 2, that the first and second parts can operate independent of each other and wherein the apparatus is arranged to selectively operate in at least:

a first mode wherein the first part and at least part of the third and fourth parts are used, the fourth part being operated under control of the first configuration data, or

a second mode wherein the second part and at least part of the third and fourth parts are used, the fourth part being operated under control of the second configuration data. For example, in a situation wherein the first part provides PC functionality and the second part provides TV functionality, the user may at power-up of the apparatus decide what he wants to do (e.g. purely watch television or perform other operations, such as browsing the Internet, managing a library of MP3 songs, etc.). The apparatus then activates the processing part associated with the instruction of the user.

The architecture also enables, as described in claim 3, to operate in a shared mode wherein the first part, second part, third part and the fourth part are used. In this mode the powers of both processing parts are joined. Both can perform specialized operations so that a higher quality performance can be achieved that can not easily be achieved with a single processing part, for example since the approach/requirements seem conflicting as is the case for graphics processing and TV signal processing.

In a preferred embodiment as described in claim 4, both the first and second part are arranged to provide audio and/or video functionality, the processing element of the first part being more powerful or more versatile than the processing element of the second part. Powerful is here expressed in processing power on a comparable basis (e.g. recalculated to a suitable expression in mega-instructions or operations per second). Typically, the second part also requires less (energetic) power. This gives the user of the apparatus the choice to let the apparatus work in the second mode (e.g. just watch TV), with the advantage of processing optimized for that purpose (e.g. an optimized image for a TV signal, i.e. higher quality), and less power consumption. Alternatively, the user can let the apparatus operate in the first mode and open up more functionality (e.g. being able to also record the video signal, manage a library of AV content, browse the Internet, etc) using the additional power, usually at the cost of a higher energy consumption.

In a preferred embodiment, the apparatus is arranged to, in response to a first trigger, start operation in the second mode and, in response to a second, sequentially later trigger, switch over to operation in the first mode. In this way, the second, low power part is responsible during starting (“booting”) of the system, e.g. in response to a trigger received via a remote control. In response to a later second trigger (e.g. an explicit request to start the first part; a request for a function not supplied by the second part but only by the first part, e.g. pressing a “browse” button on the remote control; or a signal that the first part has finished booting and is ready to take over) control is handed to the first part. In this way an apparatus with improved responsiveness is achieved.

In an embodiment as described in the dependent claim 6, the apparatus includes computer program instructions for causing the processing element of the second part to act as a co-processor for the processing element of the first part. In this way, in the shared mode responsibility is clear (typically simplifying the programs) whereas still the second processing part's power can be used.

In an embodiment, as described in the dependent claim 7, the computer program instructions are for causing the processing element of the second part to use at least one peripheral element of the third part to assist in providing the co-processing functionality. In this way, not just the processing part is used but also dedicated ICs may be used under control of the second processing part. This has the advantage that drivers that already exits for the second processing part can still be used and do not need to be ported to the first processing part. It also has the advantage that the first part does not need to be loaded further with additional drivers, decreasing performance and reliability of the first part.

In an embodiment, as described in the dependent claim 8, the apparatus includes computer program instructions for causing the processing element of the second part to act as a watch-dog for the processing element of the first part. The second part may take any suitable action if it detects that the first part no longer functions properly (e.g. it has not received signal from the first part for a predetermined period). Such action may, for example, be to switch the apparatus to the second mode permanently, or to switch the apparatus to the second mode, reset the first part and after the first part has been successfully restarted switch back to the original mode (first mode only or shared mode). In this way an apparatus is provided with improved reliability.

In a preferred embodiment, the apparatus includes a first computer program instruction set for execution by the processing element of the first part and for, upon execution, causing the apparatus to perform the function of a general purpose computing device and a second computer program instruction set for execution by the processing element of the second part and for, upon execution, causing the apparatus to perform the function of a specific AV device, in particular a television. In this way, the general purpose PC-type of world, with advantages such as openness, rapid advances in hardware and/or software, wide range of HW/SW modules, etc., can be optimally combined with the advantages specific for AV devices, such as reliability, responsiveness, and high-quality processing of television-type of signals. In this way an improved apparatus is provided that can both act as a general purpose PC as well as a Television.

In a preferred embodiment, as described in the dependent claim 9, the apparatus includes:

a computer graphics peripheral element for generating a video output image to a display; the computer graphics peripheral element being accessible through the I/O network and being controlled by the computing element of the first part;

a video processing peripheral element for processing a television signal; the video processing peripheral element being accessible through the I/O network and being controlled by the computing element of the second part; and

computer program instructions for causing the first or second computing element to assign at least one window on the video output image to be generated by the computer graphics peripheral element and at least one further window to be generated by the video processing peripheral element.

In this way, optimal graphics processing can be applied simultaneously to different parts (windows) of a display screen. Typically, the PC graphics card will generate the actual output signal (e.g. connected via DVI or HDMI to a display) where the graphics card may be responsible for the processing of content of some of the windows and the TV video processor for other windows. For example, if the user browses the Internet or plays a graphics game in one or more windows, these signals for these windows may be processed by the graphics processor. If the user in the mean time has opened a window to monitor the start of the news, this window may be processed by the TV video processor. In this example, overall responsibility may be given to the PC (first part). If on the other hand the user watches a movie in a full-screen window (processed by the TV video processor) with a small pop-up window to retrieve some additional information of the movie from the Internet (processed by the PC graphics processor), total responsibility may be given to the TV video processor. Responsibility may also be simply divided per window, as is possible using certain graphics formats, like Open-GL.

In a preferred embodiment as defined in claim 11, the I/O network is of a hierarchical switched I/O network type; the fourth part including a primary switching element (S₀) of the network. Switched networks offer, in general, a higher bandwidth and more scalability. The primary switching element is shared by both processing parts. Preferably, the I/O network is PCI Express. This is the new standard for PC-based I/O networks expected to meet current and future demand for quite some years.

In an embodiment as defined in the dependent claim 12, the first and second architecture part include a respective single first and second root element of the switched I/O network; each root element being directly connected to the respective processing element and to at least the primary switching element. The root element may be chosen specific for the first processing part, e.g. giving the performance required for the processor to access its memory. The root element can also be associated with all the configuration data relevant for its part (e.g. it may retrieve it from a BIOS in its own part). In this way it can be assured that without any problem the first or second part can also perform its functionality without requiring the other part (second part or first part respectively). It can perform its own configuration totally independently. For each root element it can be chosen independently whether or not and to which extent it provides access to elements in its part through the I/O network. Preferably, the first and second configuration data are for configuring the primary switching element and the first or second root element, respectively. In PCI Express, the root element is referred to as root complex.

In a preferred embodiment, the peripheral element on the I/O network is at least one of: an audio tuner, a video tuner, a hard disk unit, optical storage unit, solid state memory card, audio and/or video decoder, a wide or local area network interface, a teletext decoder, a USB bridge. Any combination of these may be used. A user may buy a PC (first part, third part and fourth part) with some of these and then later-on buy a TV module with the second part and optionally also one or more peripheral elements (additionally element for part three). Similarly, the user may buy a TV (part 2, 3 and 4) and later-on buy a plug-in module that gives PC functionality (part 1 and optionally some elements, such as an Internet interface, for part 3).

To meet an object of the invention, a processing assembly includes a first hardware part including a first processing element and a first memory element for providing program code to the first processing element; a third hardware part including at least one peripheral element acting as a source and/or destination of data; and a fourth hardware part including an I/O network coupled to the first and third part for enabling communication between elements of the first and third part under control of first configuration data; the fourth hardware part further including signal connections for connection to a second hardware part including a second processing element and a second memory element for providing program code to the second processing element; the fourth part being operable to receive distinct second configuration data via the signal connections to enable communication between elements of the second and third part under control of the second configuration data. It will be appreciated that in this context the first part may be any of the first or second part of the entire apparatus described above. For example, a user may buy a PC (first part, third part and fourth part) with some of these and then later-on buy an add-on TV module with the second part and optionally also one or more peripheral elements (additionally element for part three). Similarly, the user may first buy a TV (part 2, 3 and 4) and later-on buy a plug-in module that gives PC functionality (part 1 and optionally some elements, such as an Internet interface, for part 3).

These and other aspects of the invention are apparent from and will be elucidated with reference to the embodiments described hereinafter.

### BRIEF DESCRIPTION OF THE DRAWINGS

In the drawings:

FIG. 1 shows a block diagram of a prior art PCI Express architecture;

FIG. 2 shows a block diagram of an apparatus according to the invention;

FIG. 3 shows a block diagram of an embodiment for computer graphics;

FIG. 4 shows a block diagram of an alternative embodiment;

FIG. 5 shows two windows, each assigned to a respective video processor;

FIG. 6 shows a preferred embodiment based on a hierarchical switched I/O network;

FIG. 7 shows a further embodiment using a further switch;

FIG. 8 shows an apparatus with two modules; and

FIG. 9 shows a preferred PCI express embodiment.

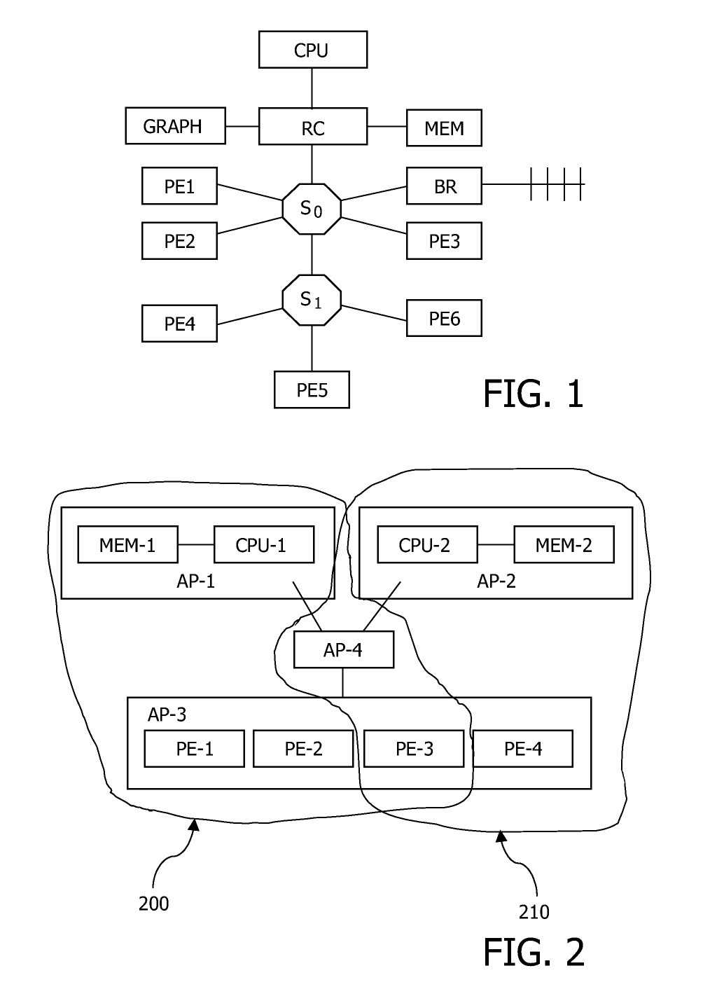

### DETAILED DESCRIPTION

Where in different figures same reference numerals or abbreviations are used, they refer to the same feature unless differences are indicated. FIG. 2 shows a schematic block diagram of the apparatus according to the invention. The apparatus includes at least two parts with hardware processing facilities. Shown are a first hardware part AP1 and a second hardware part AP2. The first part AP1 includes a processing element CPU-1 and memory element MEM-1. Instead of the memory element MEM-1 being located in the first part AP-1, the first part AP-1 may have a signal connection to the memory element MEM-1. The memory element may be fixedly located in another part of the system but may also be of a removable type, such as a USB key or memory card. The processing element CPU-1 can retrieve program code from the memory MEM-1. The memory may have all program code and associated data for the processing element CPU-1. If so desired it may only include a first part to enable effective booting of the processing element CPU-1 so that additional code may be retrieved from another memory/storage, such as a hard disk which is present as a peripheral in the third part AP-3. The memory MEM-1 may be a BIOS, such as is well-known from computer systems, it may also include the main RAM-based memory of the processing element CPU-1. The processing element may be a single-core processor, multi-core processor, multi-processor with single cores or multi-processor with multiple cores. In principle any suitable processor may be used. For the apparatus point of view it is seen as one processing element operated under one coherent set of program parts. As such the part AP-1 is defined by the processing element CPU-1 and associated program. The same holds for the second hardware part that includes at least a processing element CPU-2 and memory element MEM-2 for providing program code to the processing element CPU-2. As described above, the second part may also have only a signal connection to memory element MEM-2 where memory element MEM-2 is not fixedly located in the second part. Each of the parts AP-1 and AP-2 may also include one or more peripheral elements other than the memory MEM-1 and MEM-2 (not shown in FIG. 2). It is up to the design of the parts AP-1 and AP-2 if such peripheral elements are exclusive for the part or accessible through the I/O network AP-4.

The apparatus further includes a third hardware part AP3 including at least one peripheral element (shown are PE-1, PE-2, PE-3, and PE-4) acting as a source and/or destination of data. Preferably, the apparatus is a multi-media device, in particular capable of processing audio and/or video data (AV). Advantageously, the apparatus can also operate as a general purpose computer and can be loaded with an operating system, such as Windows or Linux, and suitable application programs and drivers to provide the user a wide range of functionality. As such, the peripheral element on the I/O network is preferably at least one of: an audio tuner, a video tuner, a hard disk unit, optical storage unit, solid state memory card, audio and/or video decoder, a wide or local area network interface, a teletext decoder, a USB bridge. Any combination of these may be used.

The apparatus further includes a fourth hardware part AP-4 including an I/O network (not shown separately in FIG. 2). The I/O network enables communication between elements of the first and third part under control of first configuration data. Effectively this forms a sub-system shown as 200. Additionally, the I/O network enables communication between elements of the second and third part under control of distinct second configuration data, forming the sub-system shown as 210. The first configuration data is preferably stored in a non-volatile memory (e.g. BIOS) in part AP-1; the second configuration data is preferably stored in a non-volatile memory in part AP-2.

In this way an architecture is made with at least two processing parts AP-1 and AP-2, that may each be targeted at specific functionality, where peripherals can easily be shared. The I/O network AP-4 is shared. Access to the peripherals by each of the processing parts is under control of respective configuration data. It is not required that each part has its own peripherals in its own part AP-1 or AP-2 with the exception of a memory.

In a preferred embodiment both the first and second part are arranged to provide at least audio and/or video functionality, the processing element of the first part being more powerful than the processing element of the second part. Powerful is here expressed in processing power on a comparable basis (e.g. recalculated to a suitable expression in mega-instructions or operations per second). Typically, the second part also requires less energy. For example, the first processing part may include a conventional PC processor, such as a Intel's Pentium 4 or AMD's Athlon, targeted at providing general purpose computer functionality. The second processing part may include a processor that is more suitable for specific AV functionality, such as a MIPS RISC processor, ARM-based embedded processor, or even a DSP (Digital Signal Processor). The second processing part may also be a multi-processor subsystem, e.g. comprising a RISC/embedded processor and a DSP.

In a preferred embodiment, the apparatus includes a first computer program instruction set (not shown) for execution by the processing element CPU-1 and for, upon execution, causing the apparatus to perform the function of a general purpose computing device. The software may include a conventional operating system, such as Windows XP or Linux. Preferably, an optimized operating system with AV application programs is used, such as Windows Media Center or Linux MythTV. The apparatus also includes a second computer program instruction set for execution by the processing element of the second part and for, upon execution, causing the apparatus to perform the function of a specific AV device, in particular a television. In this way, the general purpose PC-type of world, with advantages such as openness, rapid advances in hardware and/or software, wide range of HW/SW modules, etc., can be optimally combined with the advantages of specific AV devices, such as reliability, responsiveness, and high-quality processing of television-type of signals. The computer program instruction set may be loaded from non-volatile storage in its own part, but may also be entirely or partly loaded from a shared storage device, such as a hard disk. Preferably, the software for the second part AP-2 is loaded from a solid state non-volatile memory, such as ROM or Flash, to ensure that the apparatus can still function (partially) even if the hard disk crashes. This will give a user time to replace the faulty hard disc and reinstall the software for the first part.

The architecture according to the invention enables to operate the first and second parts independent of each other. They may also be used in a shared mode. In a first mode, the first part AP-1 and at least part of the third and fourth parts are used. In FIG. 2 this is shown as 200. In that example, the entire AP-4 is used and PE-1, PE-2, and PE-3 of AP-3 are used. AP-4 is operated under control of the first configuration data. At activation of this mode, this configuration data may be loaded and relevant parts provided to (e.g. written into registers of) at least the involved parts of AP-4 (e.g. configurable switches in AP-4). In a similar way, in a second mode the second part and at least part of the third and fourth parts are used. The fourth part is operated under control of the second configuration data. For example, in a situation wherein the first part provides PC functionality and the second part provides TV functionality, the user may at power-up of the apparatus decide what he wants to do (e.g. purely watch television or perform other operations, such as browsing the Internet, managing a library of MP3 songs, etc.). The apparatus then activates the processing part associated with the instruction of the user. The monitoring of the user instructions may be performed by one of the parts (preferably the quickest responding and/or least energy consuming part) or using a dedicated circuit. This circuit or the monitoring part may then activate the part desired by the user. Activating a processing circuit is well-known and the way of doing it is not part of this invention.

The architecture also enables the operation in a shared mode wherein the first part, second part, third part and the fourth part are used. In this mode the powers of both processing parts are joined. Both can perform specialized operations or one can be used for a specialized function whereas the other provides general purpose processing functionality.

In a preferred embodiment, the sharing is achieved by in response to a first trigger, start operation in the second mode and, in response to a second, sequentially later trigger, switch over to operation in the first mode. In this way, the low power part is responsible during the starting (“booting”) of the system. To this end, the first part may, for example, be responsible for dealing with user control input via a control device, such as a remote control. As described before, the remote control or other user input, like activating a key on the apparatus, may also be monitored using a dedicated circuit. The second part can then also decide if it is immediately required to also power-up the first part. The second part may also wait for a second trigger from the user (e.g. a request for a function not supplied by the second part but only by the first part) and then activate the first part. The second trigger may be an explicit trigger from the user, e.g. pressing a “browse” button on the remote control. The second trigger may also occur during the processing triggered by the first trigger. For example, during the processing performed by the second part it is required to download a large file through the Internet and the first part contains the drivers for this. It is then the second part that takes the initiative and generates the second trigger internally; it is responsible for starting (“booting”) of the system, e.g. in response to a trigger received via remote control. It may also be the first part that generates the second trigger. For example, at power-up of the apparatus also the first part is activated immediately. Since this one typically needs to load and initialize substantially more software and typically also uses more peripherals, it will take longer before the first part is fully operational. As soon as the first part determines that it is sufficiently capable of performing the function desired by the user it may issue a trigger to take over from the second part. It may do this in any suitable way, e.g. by changing the I/O network and resetting the second part. It may also issue a signal to the second part so that a more graceful taking-over can take place. For example, the second part can in response to detecting such a signal release control in one go or in steps and inform the first part of which peripherals it now has the main control over.

Particularly advantageous examples of a shared mode lie in where the second part acts as a co-processor and/or watchdog for the first part. To be able to operate as a co-processor CPU-2 needs to be able to control a peripheral on behalf of CPU-1 or supply data to a peripheral on behalf of CPU-1. Such peripheral is then preferably a shared element in AP-3. If so desired, output of CPU-2 may also be used as input of CPU-1. A preferred arrangement for this is where AP-3 includes as a peripheral element a shared memory. Of course also other known communication/sharing schemes between two or more CPUs may be used. To be able to operate as a watchdog, the apparatus includes computer program instructions for causing CPU-2 to act as a co-processor for CPU-1. CPU-2 may on its own perform all co-processing functionality (i.e. without using any other peripherals with the exception of a device that provided the software). Preferably, the computer program instructions are for causing CPU-2 to use at least one peripheral element of AP-3 to assist in providing the co-processing functionality. In this way, not just CPU-2 is used but also dedicated ICs may be used under control of CPU-2.

In an embodiment, the apparatus includes computer program instructions for causing CPU-2 to act as a watch-dog for CPU-1. The watchdog function may be performed in any suitable way. For example, CPU-1 may be programmed to regularly (e.g. every second) provide a trigger to CPU-2. If no such trigger was received for a predetermined period (e.g. 2 to 10 times the regular period), CPU-2 may assume that CPU-1 has crashed. CPU-2 may take any suitable action if it detects that the first part no longer functions properly. Such action may, for example, be to switch the apparatus to the second mode permanently, it may switch the apparatus to the second mode, reset the first part and after the first part has been successfully restarted switch back to the original mode (first mode only or shared mode). The watchdog may thus reconfigure the I/O network. It will be appreciated that in this context the less powerful CPU may be co-processor or watchdog, but it is also possible that the more powerful CPU is the co-processor and/or watchdog. Actually, both CPU-1 and CPU-2 could be watchdog of each other.

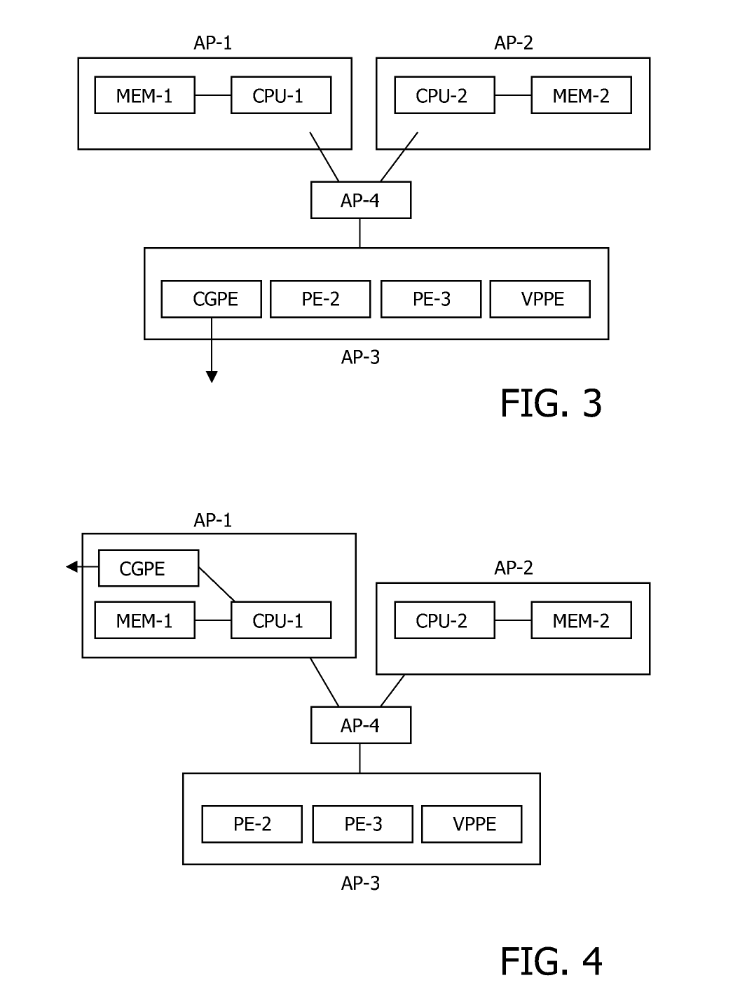

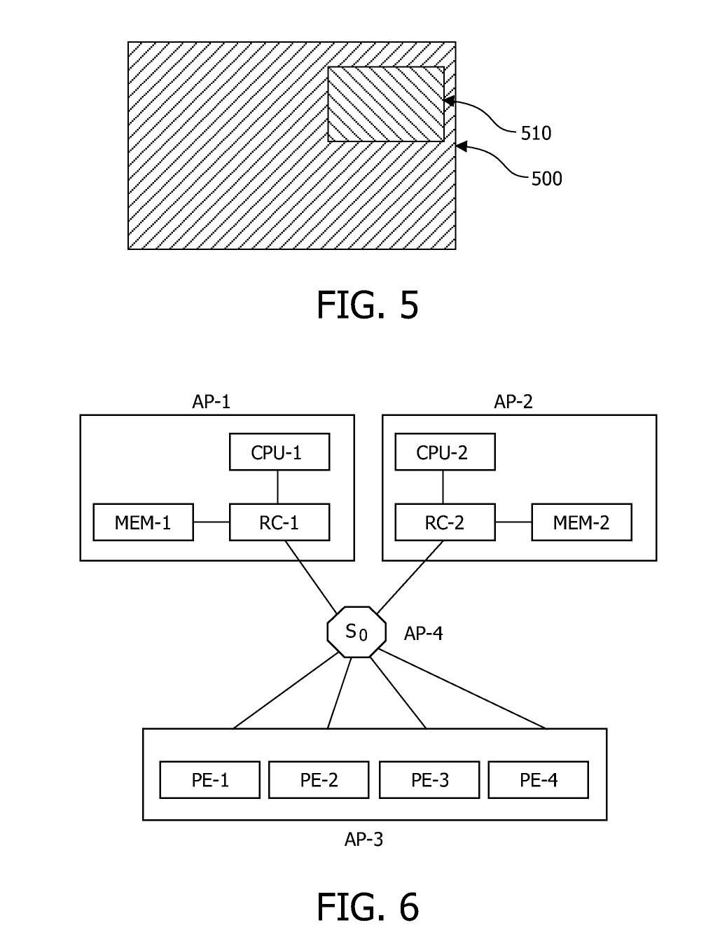

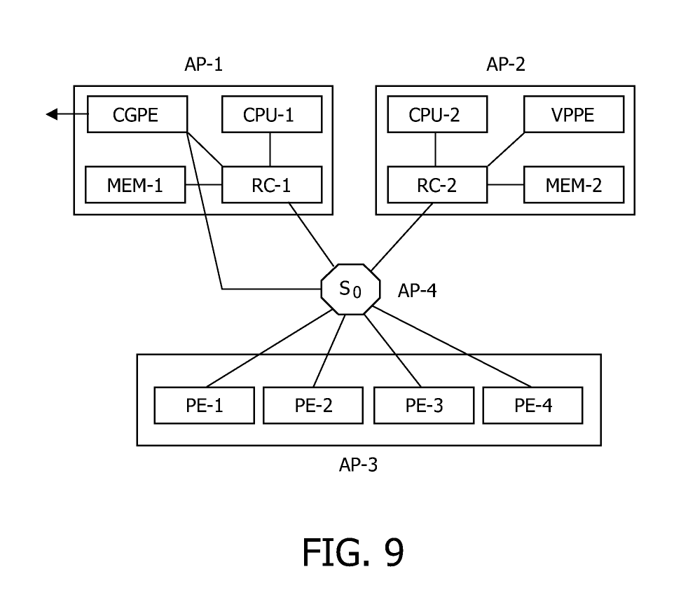

FIG. 3 illustrates a preferred embodiment wherein the apparatus includes a computer graphics peripheral element CGPE for generating a video output image to a display (the output of the element is shown as an arrow). The computer graphics peripheral element CGPE is accessible through the I/O network and is controlled by CPU-1. In the example of FIG. 3, CGPE is located in the peripheral block AP-3. It is then typically fully accessible (e.g. full bandwidth input and output). FIG. 4 shows an alternative arrangement where CGPE is located in part AP-1. This part may then determine to which extent CPGE is accessible from outside AP-1 (e.g. for output only, and possibly restricted bandwidth). Additionally, the apparatus includes a video processing peripheral element VPPE for processing a television signal. This signal may be received from outside the apparatus directly by VPPE or using an input peripheral element, e.g. with a DVI or HDMI input, for example from a set-top box or satellite receiver. The signal may also be obtained from a storage device, such as optical storage (e.g. DVD movie), hard disk or solid-state memory card. The video processing peripheral element VPPE is accessible through the I/O network and is controlled by CPU-2. In the example of FIG. 3, VPPE is located in block AP-3. If so desired it may also be located in block AP-2. In this case control may be arranged via AP-4 (an example is given in FIG. 9) or using dedicated means, e.g. a direct connection between CPU-2 and VPPE. The apparatus stores computer program instructions for causing CPU-1 or CPU-2 to assign at least one window on the video output image to be generated by the CGPE and at least one further window to be generated by the VPPE. FIG. 5 shows an example, where VPPE may be responsible for the processing of window 510. It directs its output via the I/O network to CGPE that ensures, under control of CPU-1, that the content is rendered at the right position on the screen. CGPE is in this example responsible for performing the processing of the main window 500, for as far as that one is not covered by window 510. CGPE thus has control over the shared video output buffer. This buffer will then typically be in AP-1. In this way, optimal graphics processing can be applied simultaneously to different parts (windows) of a display screen. Responsibility may be divided per window, as is possible using certain graphics formats, like Open-GL, where CGPE combines the processed window signals into one output signal.

In a preferred embodiment as shown in FIG. 6 the I/O network is of a hierarchical switched I/O network type. The fourth part AP-4 includes a primary switching element of the network. The primary switching element S₀ is thus shared by both AP-1 and AP-2.

Preferably, the I/O network is PCI Express. PCI Express in addition to a main switch also has a single root complex. In an embodiment as shown in FIG. 6, AP-1 and AP-2 include a single first and second root element RC-1 and RC-2 respectively of the switched I/O network. Each root element is directly connected to the respective processing element (RC-1 to CPU-1, RC-2 to CPU-2) and to at least the primary switching element (S₀). The root element may be chosen specific for the first processing part, e.g. giving the performance required for the processor to access its memory. The root element can also be associated with all the configuration data relevant for its part, for example it may retrieve it from a BIOS (not shown) in its own part. In itself it is generally known to persons skilled in the art of PC I/O how to configure PCI express and what data is involved. This in itself is not the subject of the invention. It will be appreciated that the main switch S₀ is now downstream of two root complexes (more in general: a plurality of root complexes). As such, the switch S₀ must be adapted to do so. Since the signal connections are all of the same PCI express type, it simply involves logic to accept configuration input and associated reporting via two connections instead of one. It is up to the specific apparatus how the configuration works. For example, if first CPU-2 is in control S₀ simply receives the first configuration data from AP-2 (e.g. through RC-2). This would be as normal. If at a later moment control switches to CPU-1, S₀ may receive new or additional configuration data through RC-1. It is up to the implementer of the apparatus to fully replace the configuration with one new set, covering both the requirements of AP-1 and AP-2 or to provide only additional information. Preferably, S₀ is designed to support both types (fully replacing or receiving additional configuration). If AP-1 replaces the existing configuration, preferably AP-1 ensures that the needs of AP-2 are still met. For example, CPU-1 or RC-1 may read the current configuration from AP-2 or associated memory and make sure these requirements are met for as far as they are not in conflict. Of course CPU-2 may also have written the configuration in a memory accessible by CPU-1 (e.g. downstream of S₀). For the reporting, also any suitable mechanism may be chosen. For example, S₀ reports to both RC-1 and RC-2 in full or only those parts relating to the configuration data issued through the involved root complex. It will also be appreciated that a root complex or CPU that is not yet in a controlling role may actually act as a conventional peripheral on PCI express.

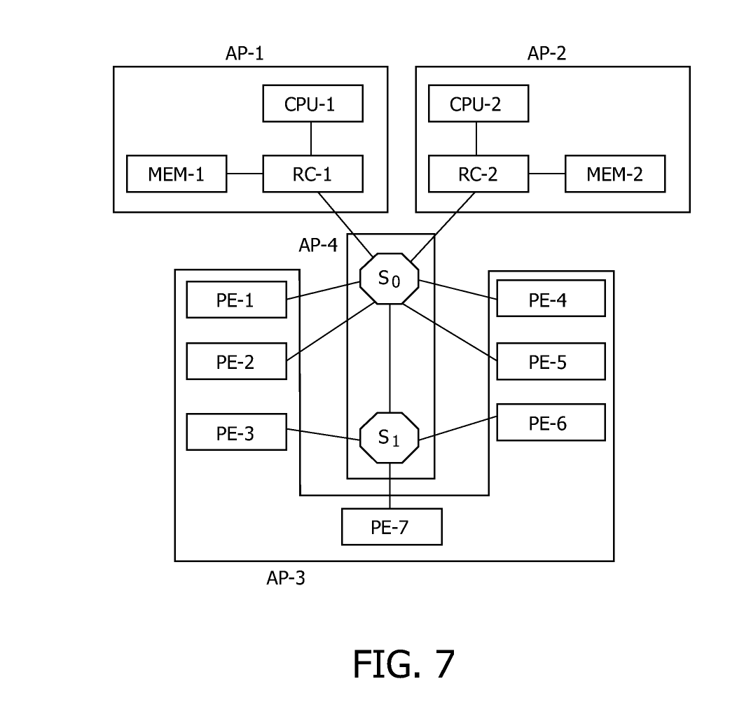

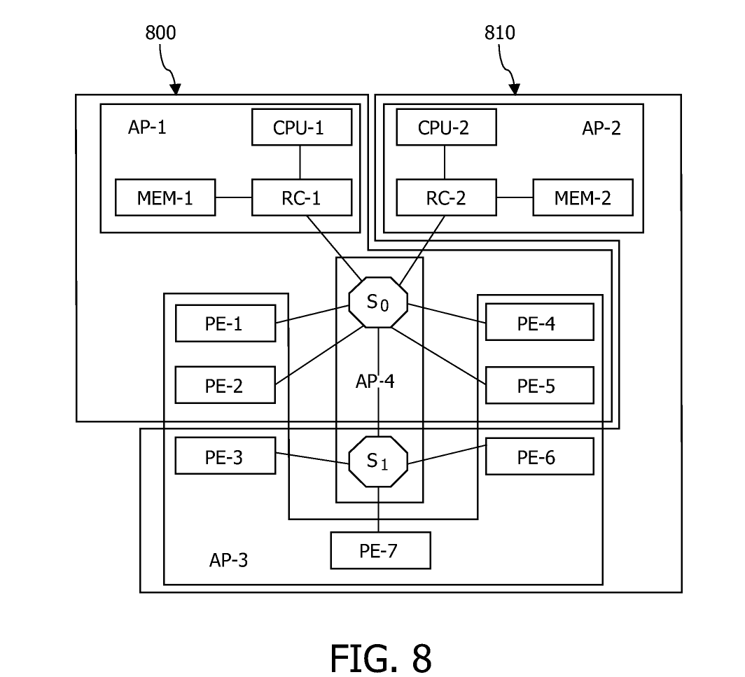

FIG. 7 shows an arrangement wherein the I/O network AP-4 includes a further switch S₁, hierarchically downstream of S₀ with respect to the root complexes. A further example is given in FIG. 8 where the apparatus is divided in two modules, only one including the main switch S₀. In this example, the main module 800 includes AP-1, AP-4 and four peripheral elements (PE-1, PE-2, PE-4, and PE-5) of AP-3. The add-on module 810 includes AP-2, three peripheral elements (PE-3, PE-6 and PE-7) of AP-3 and the second switch S₁ of AP-4. In this example, module 800 might be a PC where module 810 is an add-on TV or other type of CE module. By also including a switch in the add-on module that is connected to all peripherals of the add-on module that may be freely accessed, the add-on module influences the configuration of the main module less then if the peripherals were directly added to S₀. Module 800 is an example of a processing assembly that includes a first hardware part (in this case AP-1) including a first processing element (in this case CPU-1) and a first memory element (in this case MEM-1) for providing program code to the first processing element. The processing assembly also includes a third hardware part including at least one peripheral element acting as a source and/or destination of data (in this case some peripheral elements of AP3). The processing assembly also includes a fourth hardware part (in this case S0 of AP-4) including an I/O network coupled to the first an third part for enabling communication between elements of the first and third part under control of first configuration data. The fourth hardware part further including signal connections for connection to a second hardware part (in this case AP2) including a second processing element (in this case CPU-2) and a second memory element (in this case MEM-2) for providing program code to the second processing element. The fourth part AP-4 is operable to receive distinct second configuration data via the signal connections from the second part to enable communication between elements of the second and third part under control of the second configuration data. In this way, the add-on module 810 can simply be plugged-in and also the processor on this module can independently control the network. It will be appreciated that also AP-2 may be the core of the main module (that module having S₀) where AP-1 is on the add-on module.

FIG. 9 shows a preferred embodiment, the hardware parts AP-1 and AP-2 include respectively the computer graphics peripheral element (CGPE) and video processing peripheral element (VPPE). To provide video output from VPPE to CPPE, CPPE is also directly connected to the I/O network AP4, in this case to the main switch S₀ of the network. S₀ thus has an upstream connection to the root element RC-1 of AP-1 and a downstream connection to CGPE.

In a preferred embodiment it is not the user that directly controls the mode in which the apparatus works, but the apparatus includes a timer device (not shown) that additionally may trigger it. Preferably, the timer is of a low-power type. The user may set the timer in any conventional way. The timer may support any of the following:
trigger booting of AP-2 (or if so desired AP-1)
trigger the start of an application controlled by AP-1 or AP-2. This may involve booting AP-1 or AP-2 if not yet active. Preferably, the timer is preprogrammed with the boot-delay of AP-1 and/or AP-2 so that the booting can be started in time for the application to start at the programmed time.
select a desired AV source (e.g. video tuner, audio tuner, audio-CD, DVD, etc.) and/or where applicable the channel. This may also cover Internet radio, Internet video and other Internet AV sources, such as Podcasting.
switch-off the system at a user programmed time.

It will also be appreciated that instead of building a ‘combination’ apparatus offering a combination of two essentially different functionalities, such as a combination of a PC and TV, it is also possible to build a modular apparatus that keeps on offering similar functionality, albeit at different quality and/or reliability. For example, AP-1 might cover the processing of a basic TV or basic CE apparatus in general. The main module might then include AP-2, and (part of) AP-4 and AP-3. This module might provide a TV-receiver and optionally basic optical storage functionality, such as playback of an audio CD, conventional recording on a hard disk or optical storage. The add-on module might add a more advanced processor in the form of part AP-1 and optionally one or more additional peripherals, such as Internet access or a second tuner. In shared mode, the add-on module might provide additional functions such as double-window TV, PIP (picture in picture), internet browsing in a window while watching the TV, time-slip recording, etc. If so desired, the add-on module might also provide applications typically associated with a PC, such as playing games. Preferably, the add-on module also supports more advanced image processing functions, such as the Philips Pixel Plus and Natural Motion video processing functions.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An apparatus including at least a first hardware part (AP1) and a second hardware part (AP2), where each of the first and second part include a respective processing element (CPU-1, CPU-2) and a respective signal connection to a respective memory element (MEM-1, MEM-2) for providing program code to the processing element of the respective part;
the apparatus further includes a third hardware part (AP3) including at least one peripheral element acting as a source and/or destination of data; and a fourth hardware part including an I/O network (AP-4) for enabling communication between elements of the first and third part under control of first configuration data and for enabling communication between elements of the second and third part under control of distinct second configuration data.

2. An apparatus as claimed in claim 1, wherein the first and second parts are arranged to operate independently of each other and wherein the apparatus is arranged to selectively operate in at least:
a first mode wherein the first part and at least part of the third and fourth parts are used, the fourth part being operated under control of the first configuration data, or
a second mode wherein the second part and at least part of the third and fourth parts are used, the fourth part being operated under control of the second configuration data.

3. An apparatus as claimed in claim 1, wherein the apparatus is arranged to operate in a shared mode wherein the first part, second part, third part and the fourth part are used.

4. An apparatus as claimed in claim 1, wherein both the first and second part are arranged to provide audio and/or video functionality, the processing element of the first part being more powerful or more versatile than the processing element of the second part.

5. An apparatus as claimed in claim 2, wherein the apparatus is arranged to, in response to a first trigger, start operation in the second mode and, in response to a second, sequentially later trigger, switch over to operation in the first mode.

6. An apparatus as claimed in claim 3, wherein the apparatus includes computer program instructions for causing the processing element of the second part to act as a co-processor for the processing element of the first part.

7. An apparatus as claimed in claim 6, wherein the computer program instructions are for causing the processing element of the second part to use at least one peripheral element of the third part to assist in providing the co-processing functionality.

8. An apparatus as claimed in claim 3, the apparatus includes computer program instructions for causing the processing element of the second part to act as a watch-dog for the processing element of the first part.

9. An apparatus as claimed in claim 1, wherein the apparatus includes a first computer program instruction set for execution by the processing element of the first part and for, upon execution, causing the apparatus to perform the function of a general purpose computing device and a second computer program instruction set for execution by the processing element of the second part and for, upon execution, causing the apparatus to perform the function of a specific AV device, in particular a television.

10. An apparatus as claimed in claim 9, wherein the apparatus includes:
a computer graphics peripheral element for generating a video output image to a display; the computer graphics peripheral element being accessible through the I/O network and being controlled by the computing element of the first part;
a video processing peripheral element for processing a television signal; the video processing peripheral element being accessible through the I/O network and being controlled by the computing element of the second part; and
computer program instructions for causing the first or second computing element to assign at least one window on the video output image to be generated by the computer graphics peripheral element and at least one further window to be generated by the video processing peripheral element.

11. An apparatus as claimed in claim 1, wherein the I/O network is of a hierarchical switched I/O network type; the fourth part including a primary switching element (S₀) of the network.

12. An apparatus as claimed in claim 11, wherein the first and second architecture part include a respective single first and second root element (RC-1, RC-2) of the switched I/O network; each root element being directly connected to the respective processing element (CPU-1, CPU-2) and to at least the primary switching element (S₀).

13. An apparatus as claimed in claim 12, wherein the first and second configuration data are for configuring the primary switching element and the first or second root element, respectively.

14. An apparatus as claimed in claim 11, wherein the I/O network is PCI Express.

15. An apparatus as claimed in claim 1, wherein the peripheral element is at least one of: an audio tuner, a video tuner, a hard disk unit, optical storage unit, solid state memory card, audio and/or video decoder, a wide or local area network interface, a teletext decoder, a USB bridge.

16. A processing assembly including a first hardware part (AP-1) including a first processing element (CPU-1) and signal connection to a first memory element (MEM-1) for providing program code to the first processing element; a third hardware part (AP3) including at least one peripheral element acting as a source and/or destination of data; and a fourth hardware part including an I/O network (AP-4) coupled to the first an third part for enabling communication between elements of the first and third part under control of first configuration data; the fourth hardware part further including a signal connection for connection to a second hardware part (AP2) including a second processing element (CPU-2) and a signal connection to a second memory element (MEM-2) for providing program code to the second processing element; the fourth part being operable to receive distinct second configuration data via the signal connection to enable communication between elements of the second and third part under control of the second configuration data.
